(19) United States
(12) Patent Application Publication
(10) Pub. No.: US 2024/0190309 A1
(43) Pub. Date: Jun. 13, 2024

(54) BACKREST ADJUSTING MECHANISM AND A SEAT WITH THE SAME

(71) Applicant: Quality Life Technologies., Ltd., Dongguan City (CN)

(72) Inventor: Chenghui Tang, Dongguan City (CN)

(21) Appl. No.: 18/581,886

(22) Filed: Feb. 20, 2024

Related U.S. Application Data
(63) Continuation of application No. 17/654,165, filed on Mar. 9, 2022.

(51) Int. Cl. B60N 2/23; B60N 2/235

(52) U.S. Cl. CPC B60N 2/23; B60N 2/2362

(57) ABSTRACT

The backrest adjusting mechanism includes an adjusting base, a cushion, a supporting frame, a backrest, an air pressure rod, a connecting rod and a steel wire core; the cushion is fixed to a top of the adjusting base; the supporting frame is rotationally connected to a rear end of the adjusting base; the backrest is fixed on the supporting frame; the air pressure rod is rotationally connected with the supporting frame; the rear end of the base is provided with a fixing frame; the connecting rod is rotationally connected with the fixing frame and a movable rod; the connecting rod and the fixing frame are both provided with a limiting block; when the backrest is used, two of the limiting blocks are propped against each other to fix the backrest at a specific position.

### CROSS REFERENCE TO RELATED APPLICATION

This application is a continuation of U.S. application Ser. No. 17/654,165, entitled “BACKREST ADJUSTING MECHANISM AND A SEAT WITH THE SAME” filed on Mar. 9, 2022, and the entire contents of which are incorporated herein by reference.

### FIELD OF THE INVENTION

The present disclosure relates to the technical field of electric vehicles, particularly a backrest adjusting mechanism and a seat with the same.

### BACKGROUND OF THE INVENTION

The vehicle is an indispensable means of transportation in daily life. Particularly, automobiles and motorcycles almost become a part of the life of modern people. However, because fuel motor vehicles such as motorcycles or automobiles generally have the problem of air pollution. Under the trend of pursuing environmental protection as much as possible at present, very environmentally friendly electric scooters are generated correspondingly.

For convenient storage and transportation in daily life, the seats in the existing electric scooters mostly adopt the foldable design, but the backrests of the seats can only be fixed at a position forming a specific angle with a cushion when being pulled up. And for different users, the needs for angles between the backrests and the cushion are different, thereby causing inconvenience.

And, in the prior art, in using, to meet the different needs, the angle between the cushion and the backrest in a seat can be adjusted appropriately. However, when adjusting the angle between the cushion and the backrest, the backrest moves too fast, accompanied by impact, vibration, and other problems, which will seriously affect the use of users and shorten the service life of the seat.

### SUMMARY OF THE INVENTION

The object of the present disclosure is to provide a backrest adjusting mechanism, solving the problem that the backrest of the seat of the existing electric scooter can only be fixed at a position forming a specific angle with a cushion when being pulled up, and for different users, the needs on the angle between the backrest and the cushion are different, so that inconvenience is caused.

The second object of the present disclosure is to solve the problems that when adjusting the angle between the cushion and the backrest, the backrest moves too fast, accompanied by impact, vibration, and other problems, which will seriously affect the use of users and shorten the service life of the seat.

The backrest adjusting mechanism includes an adjusting base, a cushion, a supporting frame, a backrest, an air pressure rod, a connecting rod and a steel wire core.

The cushion is fixed to a top of the adjusting base; the supporting frame is rotationally connected to a rear end of the adjusting base; the backrest is fixed on the supporting frame; the air pressure rod is rotationally connected with the supporting frame; the rear end of the adjusting base is provided with a fixing frame; one end of the connecting rod is rotationally connected on the fixing frame, the other end said connecting rod is rotationally connected with a movable rod in the air pressure rod; the connecting rod and the fixing frame are both provided with a limiting block; when the backrest is used, two of the limiting blocks are propped against each other to fix the backrest at a specific position; one side of the base is actively connected with a buckle plate; one end of the steel wire core is fixed on a valve core switch of the air pressure rod, the other end of the steel wire core is fixed on the buckle plate.

Preferably, the air pressure rod can drive an included angle between the backrest and the adjusting base to be changed in a range of 100°˜120°.

Preferably, a bottom of the adjusting base is provided with a protective tube, one end of the protective tube is fixed on the adjusting base, and the other end of the protective tube is fixed on the movable rod of the air pressure rod; the steel wire core is received in the protective tube.

Preferably, one side of the adjusting base is fixed with two lower supporting lugs; two ends of the buckle plate are actively connected on the two lower supporting lugs.

Preferably, a rear end of the supporting frame is fixed with two upper supporting lugs; the air pressure rod is rotationally connected to the two upper supporting lugs.

Preferably, two ends of the steel wire core are respectively provided with a clamping block; the buckle plate and the valve core switch of the air pressure rod are respectively provided with a clamping groove corresponding to the clamping block; the clamping block is clamped in the clamping groove.

Preferably, the bottom of the adjusting base is provided with a plurality of mounting holes and a plurality of mounting grooves.

The technical effect of the backrest adjusting mechanism in the present disclosure is as follows:

The supporting frame is rotationally connected with the adjusting base so that the backrest and the cushion can be folded, and when the cushion is pulled up, the backrest is fixed on a position with an included angle of 100° with the cushion by two limiting blocks, then the buckle plate is controlled to drive the steel wire core to trigger the valve core switch of the air pressure rod, so that the backrest and the cushion can be fixed at any included angle between 100°˜120°, so as to meet the needs of different people.

A seat with an adjustable backrest includes a cushion and a backrest, the backrest is rotationally connected on one side of the cushion, a bottom of the cushion is provided with an adjusting base, the adjusting base is provided with a backrest adjusting mechanism for adjusting the rotating angle of the backrest backward; the angle adjusting mechanism comprises an adjusting handle, a limiting and sliding block, an air pressure rod and a steel inhaul cable.

The adjusting base comprises an adjusting plate installed at the bottom of the cushion, and a supporting plate extending upwards along one side of the adjusting plate.

One end of the adjusting handle is rotationally connected with the adjusting plate, and the other end is a free end extending out of the cushion, forming a handle for a user to apply force.

The limiting and sliding block is sliding connection with the supporting plate, one side, close to the adjusting plate, of the limiting and sliding block is fixed with a rotating shaft, and the other side, far away from the adjusting plate, is propped against the bottom of the backrest.

The cylinder body of the air pressure rod is rotationally connected with the rotating shaft; a movable rod of the air pressure rod is fixed on the adjusting plate; and the movable rod is provided with a valve core switch, which is used to control the opening or closing of the air pressure rod.

The steel inhaul cable is actively connected with the adjusting plate, one end of the steel inhaul cable is fixed with the valve core switch, and the other end of the steel inhaul cable is fixed with the adjusting handle.

When using, pulling the adjusting handle outwards for pulling the steel inhaul cable to open the valve core switch, so that the movable rod of the air pressure rod can do telescopic movement, and push the limiting and sliding block to move upwards and downwards along the supporting plate.

Preferably, the rotating angle that the backrest can be rotated is in a range of 0°˜120°.

Preferably, the steal inhaul cable includes a protective tube and a steel wire core; and the protective tube is sleeved on an outer surface of the steel wire core, the steel wire core is received in the protective tube and can be slid in it.

Preferably, the limiting and sliding block is provided with sliding columns, the supporting plate is provided with sliding grooves corresponding to the positions of the sliding columns; the sliding columns extend into the sliding grooves and are sliding connection with the sliding groove.

Preferably, each of the sliding grooves is provided with an elastic buffer piece, one end of which is fixed in the sliding groove, the other end is propped against one side of the limiting and sliding block close to the cushion.

The technical effect of the backrest adjusting mechanism in the present disclosure is as follows:

The present disclosure uses the air pressure rod to drive the limiting and sliding block to move, the limiting and sliding block can randomly adjust the moving distance in a stroke range of the movable rod of the air pressure rod, it is easier to meet the needs of the users. The user releases the adjusting handle at any position in the stroke range of the movable rod of the air pressure rod, the valve core switch is closed, the movable rod is fixed at a certain position, finishing adjustment of the backrest. In the process of the air pressure rod being pushed, the moving speed of the air pressure rod is stable, and combining that the elastic buffer piece, which can realize shock absorption to the limiting and sliding block, which can avoid the adjustment speed of the backrest too fast, and accompanied with impact, vibration and other problems.

A seat with an adjustable backrest includes a cushion and a backrest, the backrest is rotationally connected on one side of the cushion, a bottom of the cushion is equipped with an adjusting base, the adjusting base is provided with a backrest adjusting mechanism for adjusting the rotating angle of the backrest.

Preferably, the rotating angle adjusting mechanism comprises an adjusting handle, a limiting and sliding block and a torsion spring.

The adjusting base comprises an adjusting plate installed at the bottom of the cushion, and a supporting plate extending upwards along one side of the adjusting plate, the adjusting plate is provided with a clamping part.

The limiting and sliding block is sliding connection with the supporting plate, one side, close to the adjusting plate, of the limiting and sliding block is fixed with a rotating shaft, one side, far away from the adjusting plate, is propped against the bottom of the backrest.

One end of the adjusting handle is fixed with a gear adjusting block, the other end of the adjusting handle extends out of the adjusting base, forming a handle for pulling; the gear adjusting block is provided with a clamping block actively connected with the clamping part, and a connecting part is rotationally connected with the rotating shaft;

The torsion spring is sleeved on the rotating shaft, two ends thereof are respectively extended with a torsion arm, one end of the torsion arms is fixedly connected with the gear adjusting block, the other end of the torsion arms is fixed with the limiting and sliding block.

Preferably, the rotating angle that the backrest can be rotated is in a range of 0°˜130°.

Preferably, the clamping part is composed of three clamping grooves arranged in turn from left to right, when assembling, the clamping block is just located in any one of the three clamping grooves.

Preferably, a bump is arranged between the two adjacent clamping grooves, the left side of the bump is provided with a circular arc part connected with s top of the right side wall of the clamping groove.

Preferably, the limiting and sliding block is provided with sliding columns, the supporting plate is provided with sliding grooves corresponding to the positions of the sliding columns; the sliding columns extend into the sliding grooves, and is sliding connection with the sliding grooves.

Preferably, each of the sliding grooves is provided with an elastic buffer piece, one end of the elastic buffer piece is fixed with the sliding groove, the other end of the elastic buffer piece is fixed with one side of the limiting and sliding block close to the adjusting plate.

Preferably, the bump is located in the right one of the three clamping grooves, the backrest can rotate towards the right at an angle 10°.

Preferably, the bump is located in the left one of the three clamping grooves, the backrest can rotate towards the right at an angle 30°.

The technical effect of the backrest adjusting mechanism in the present disclosure is as follows:
1. the backrest can be rotated to be folded on the cushion, when the user is not used, it is convenient to store. When the user uses the seat, the user only needs to rotate the backrest from the cushion, which can improve the comfort of the seat.
2. Using the adjusting handle to twist the torsional spring so as to store and release angle energy by the torsion spring or through the shaft rotating force arm around the torsional spring to statically fix the bump and the clamping grooves on the gear adjusting block, ensuring the stability of the gear adjusting block, so that the limiting and sliding block is not easy to loose.
3. The limiting and sliding block is connected in the sliding grooves of the supporting plate through the sliding columns; the present disclosure is provided with an elastic buffer piece in each of the sliding groove to buffer the impact force between the backrest and the limiting and sliding block.

### BRIEF DESCRIPTION OF THE DRAWINGS

FIG. 1 is a perspective view of the backrest adjusting mechanism according to an embodiment in the present disclosure in a using state;

FIG. 2 is an enlarged view of the part A in FIG. 1;

FIG. 3 is a local decomposition view of the backrest adjusting mechanism according to the present disclosure;

FIG. 4 is a perspective view of the backrest adjusting mechanism according to the present disclosure in a folded state;

FIG. 5 is a perspective view of the backrest adjusting mechanism according to the other embodiment in the present disclosure;

FIG. 6 is a perspective view of the backrest adjusting mechanism shown in FIG. 5 in another view angle;

FIG. 7 is a decomposition view of the backrest adjusting mechanism shown in FIG. 5;

FIG. 8 is a perspective view of the backrest adjusting mechanism according to another embodiment in the present disclosure;

FIG. 9 is a perspective view of the backrest and cushion folded in the backrest adjusting mechanism shown in FIG. 8;

FIG. 10 is the other perspective view of the backrest adjusting mechanism shown in FIG. 8 in the other view angle;

FIG. 11 is a decomposition view of the backrest adjusting mechanism removed the cushion shown in FIG. 8;

FIG. 12 is another perspective view of the backrest adjusting mechanism shown in FIG. 8 in the other view angle;

FIG. 13 is an enlarged view of the part B in FIG. 12.

### DETAILED DESCRIPTION OF ILLUSTRATED EMBODIMENTS

In order to make the purpose of the present disclosure, technical solution and advantages are more clearly understood, with reference to the accompanying drawings and examples, the present disclosure is further explained in detail. It should be understood that the specific embodiment described herein is only for explaining the present disclosure, and not for defining the present disclosure.

It should be noted that, when the element is referred to as “fixed to” or “set on” another element, it can be directly on the other element or may exist in the middle element at the same time; When one element is referred to as “connected to” another element, it may be directly connected to another element or may be present at the same time as the centering element.

### Embodiment One

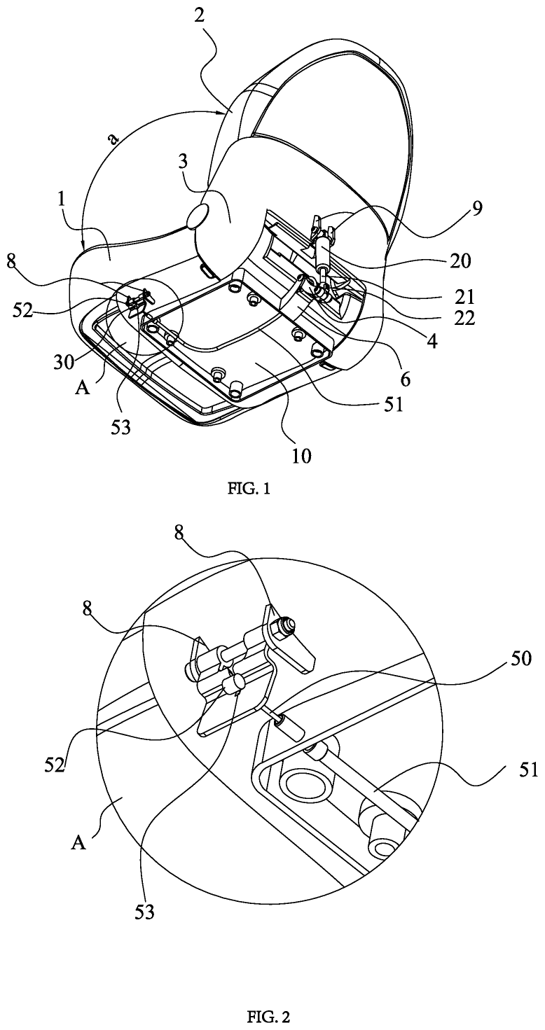

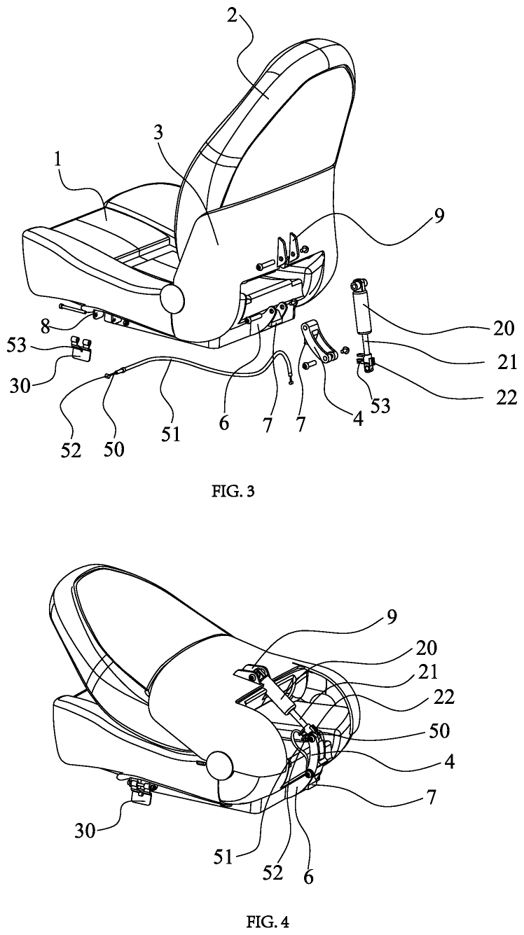

Referring to FIG. 1 to FIG. 4, a backrest adjusting mechanism includes an adjusting base 10, a cushion 1, a supporting frame 3, a backrest 2, an air pressure rod 20, a connecting rod 4 and a steel wire core 54.

The cushion 1 is fixed to a top of the adjusting base 10; the supporting frame 3 is rotationally connected to a rear end of the adjusting base 10; the backrest 2 is fixed on the supporting frame 3; the air pressure rod 20 is rotationally connected with the supporting frame 3; the rear end of the adjusting base 10 is provided with a fixing frame 6; one end of the connecting rod 4 is rotationally connected on the fixing frame 6, the other end of the connecting rod 4 is rotationally connected with a movable rod 21 in the air pressure rod 20; the connecting rod 4 and the fixing frame 6 are both provided with a limiting block 7; when the backrest 2 is used, two of the limiting blocks 7 are propped against each other to fix the backrest 2 at a specific position; one side of the adjusting base 10 is actively connected with a buckle plate 30; one end of the steel wire core 54 is fixed on a valve core switch 22 of the air pressure rod 20, the other end of the steel wire core 54 is fixed on the buckle plate 30.

In a preferably technical scheme in the present disclosure, the air pressure rod 20 can drive the rotating angle between the backrest 2 and the adjusting base 10 to be changed in a range of 100°˜120°.

In a preferably technical scheme in the present disclosure, the steel wire core 54 is in a protective tube 51 used for avoiding damage to the steel wire core 54.

In a preferably technical scheme in the present disclosure, one side of the adjusting base 10 is fixed with two lower supporting lugs 8; two ends of the buckle plate 30 are actively connected on the two lower supporting lugs 8.

In a preferably technical scheme in the present disclosure, the back end of the supporting frame 3 is fixed with two upper supporting lugs 9; the air pressure rod 20 is rotationally connected to the two upper supporting lugs 9.

In a preferably technical scheme in the present disclosure, two ends of the steel wire core 54 are respectively provided with a clamping block 52; the buckle plate 30 and the valve core switch 22 of the air pressure rod 20 are provided with a clamping groove 53 corresponding to the clamping block 52; the clamping block 52 is clamped in the clamping groove 53.

In a preferably technical scheme in the present disclosure, the bottom of the adjusting base 10 is provided with a plurality of mounting holes 18 and mounting grooves 19.

The working process of the present disclosure is as follows:
when using the electric vehicle, the backrest 2 on the seat is pulled up, the limiting block 7 of the fixing frame 6 and the limiting block 7 of the connecting rod 4 are propped against each other, at this time, the included angle α between the backrest 2 and the cushion 1 is 100°, then by pulling the buckle plate 30 to drive the steel inhaul cable 50 to trigger the valve core switch 22 of the air pressure rod 20. The air pressure rod 20 generates a force to push the backrest 2, while the user applies force to the backrest 2 through the user's back or hand to push the movable rod 21 of the air pressure rod 20 inwards, so as to control the included angle α between the backrest 2 and the cushion 1 at any suitable angle. Loosening the buckle plate 30 to make the steel wire core 54 recovery so that the valve core switch 22 of the air pressure rod 20 is closed, the backrest 2 and the cushion 1 are fixed at a corresponding position.

### Embodiment 2

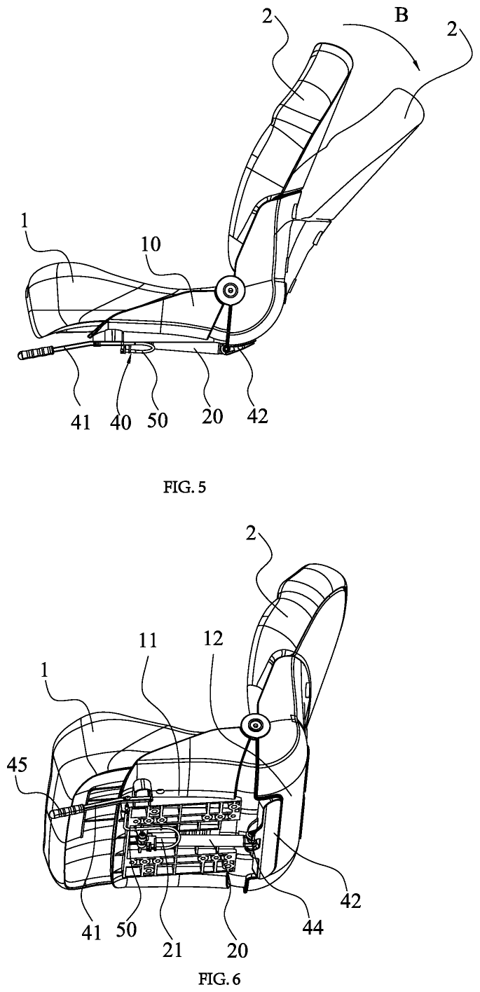

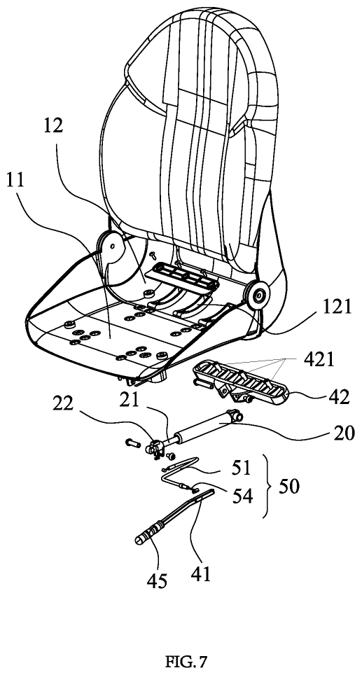

Please refer to FIG. 5-7, a backrest adjusting mechanism includes a cushion 1 and a backrest 2, the backrest 2 is rotationally connected on one side of the cushion 1, a bottom of the cushion 1 is provided with an adjusting base 10, the adjusting base 10 is provided with a backrest adjusting mechanism 40 for adjusting the rotating angle of the backrest 2 backward; the backrest adjusting mechanism 40 comprises an adjusting handle 41, a limiting and sliding block 42, an air pressure rod 20 and a steel inhaul cable 50.

The adjusting base 10 comprises an adjusting plate 11 installed at the bottom of the cushion 1, and a supporting plate 12 extending upwards along one side of the adjusting plate 11.

One end of the adjusting handle 41 is rotationally connected with the adjusting plate 11, the other end of the adjusting handle 41 extends out of the cushion 1, forming a handle 45 for the user to apply force.

The limiting and sliding block 42 is sliding connection with the supporting plate 12. One side, close to the adjusting plate 11, of the limiting and sliding block 42 42 is fixed with a rotating shaft 44, one side, far away from the adjusting plate 11, is propped against the bottom of the backrest 2.

The cylinder body of the air pressure rod 20 is rotationally connected with the rotating shaft 44; the movable rod 21 of the air pressure rod 20 is fixed on the adjusting plate 11; and the air pressure rod 20 is provided with a valve core switch 22, which is used to control the opening or closing of the air pressure rod 20. When the valve core switch 22 is opening, the movable rod 21 of the air pressure rod 20 can do a telescopic movement. When the valve core switch 22 is closed, the movable rod 21 of the air pressure rod 20 is fixed, it can not do telescopic movement anymore.

The steel inhaul cable 50 is actively connected on the adjusting plate 11, one end of the steel inhaul cable 50 is fixed with the valve core switch 22, the other end of the steel inhaul cable 50 is fixed with the adjusting handle.

When using, pulling the adjusting handle 11 outwards, for pulling the steel inhaul cable 50 to open the valve core switch 22, so that the movable rod 21 of the air pressure rod 20 can do telescopic movement, and push the limiting and sliding block 42 to move upwards and downwards along the supporting plate 12.

Preferably, the rotating angle that the backrest 2 can be rotated is in a range of 0°˜120°.

Preferably, the steal inhaul cable 50 includes a protective tube 51, a steel wire core 54, the protective tube 51 is sleeved on the outer surface of the steel wire core 54, the steel wire core 54 is sliding connection in the protective tube 51.

Preferably, the limiting and sliding block 42 is provided with sliding columns 421, the supporting plate 12 is provided with sliding grooves 121 corresponding to the positions of the sliding columns 421; the sliding columns 421 extend into the sliding grooves 121, and are sliding connection with the sliding groove 121.

Preferably, each of the sliding grooves 121 is provided with an elastic buffer piece 123, one end of which is fixed with the sliding groove 121, the other end is propped against one side of the limiting and sliding block 42 close to the cushion 1.

The working principle of the present disclosure is as follows:
when the backrest 2 and the cushion 1 is in a folded state, the included angle α is equal to 0, at this time, the backrest 2 and the limiting and sliding block 42 are separated.

When the backrest 2 is opened, the included angle α is equal to 100°, at this time, the bottom of the backrest 2 and the top part of the limiting and sliding block 42 is propped against for limiting the backrest 2 to rotate backward.

When the user adjusts the backrest 2, only needs to pull the adjusting handle 41, the adjusting handle 41 pulls the steel inhaul cable 50, the other end of which pulls the valve core switch 22 of the air pressure rod 20 so that the movable rod 21 of the air pressure rod 20 can do a telescopic movement.

At this time, the user controls the backrest 2 to be folded forwards or be rotated backward by his hand or his back, such as the backrest 2 to continue to rotate backward (i.e., the backrest 2 continues to rotate along the B direction shown in FIG. 5), the backrest 2 can push the limiting and sliding block 42 to move downwards. The movable rod 21 of the air pressure rod 20 can do shrink motion driving the cylinder body of the air pressure rod 20 to move, the cylinder body of the air pressure rod 20 drives the limiting and sliding block 42 to move downwards until the backrest 2 rotates to a specified angle, then releases the adjusting handle 41, then the valve core switch 22 is closed, the movable rod 21 of the air pressure rod 20 stops moving for fixing the limiting and sliding block 42 and making it not continuously move. But also because the backrest 2 and the limiting and sliding block 42 are propped against each other, the backrest 2 can not rotate to the right, so as to finish the adjustment of the backrest 2.

Although it should be noted that when 100°≤α≤120°, the backrest 2 can be randomly adjusted at any of the rotating angle, that, only by pulling the adjusting handle 41 to drive the steel inhaul cable 50 to open or close the valve core switch 22 of the air pressure rod 20, can realize the adjustment of the backrest 2.

In the present disclosure, using the air pressure rod 20 to drive the limiting and sliding block 42 to move, the limiting and sliding block 42 can randomly be adjusted the moving distance in the stroke range of the movable rod 21 of the air pressure rod 20, it is easier to meet the needs of the different user. The users release the adjusting handle 41 at any position in the stroke rang of the movable rod 21 of the air pressure rod 20 to close the valve core switch 22, that is to say, the length of the movable rod 21 is fixed at a certain position, finishing the adjustment of the backrest 2. And in the process of the air pressure rod 20 being pushed, the moving speed of the movable rod 21 is stable, combining that the elastic buffer piece 123 realizes shock absorption to the limiting and sliding block 42, which can avoid the adjustment speed of the backrest 2 too fast, and accompanied with impact, vibration, and other problems.

### Embodiment 3

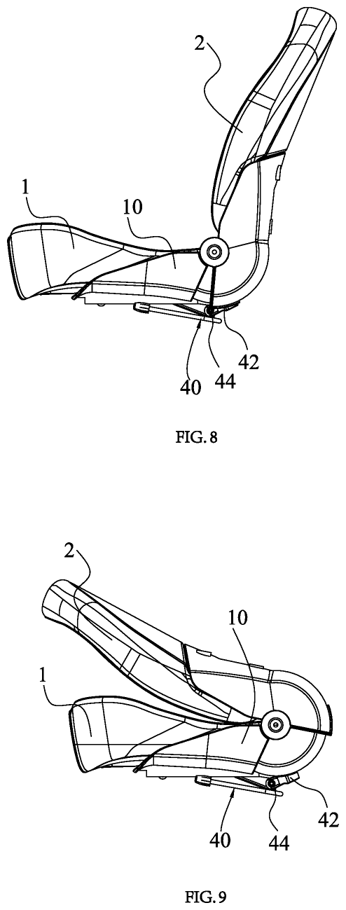

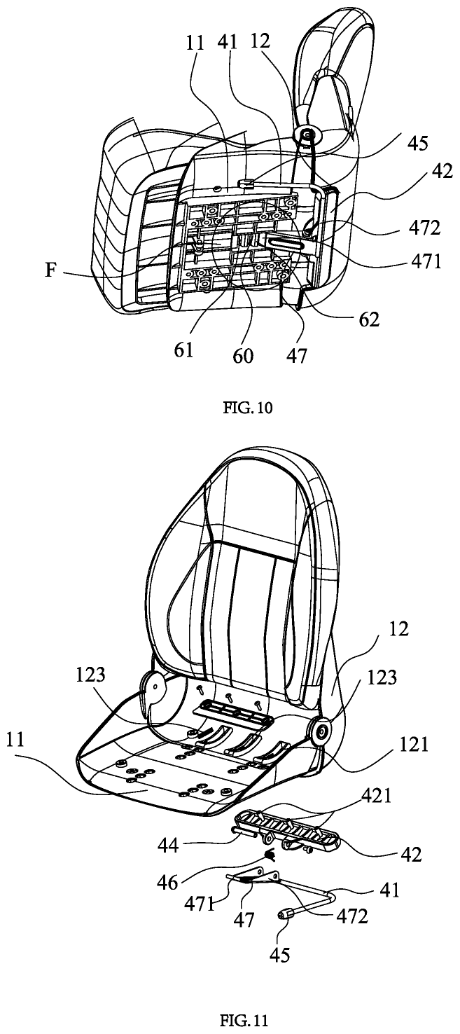

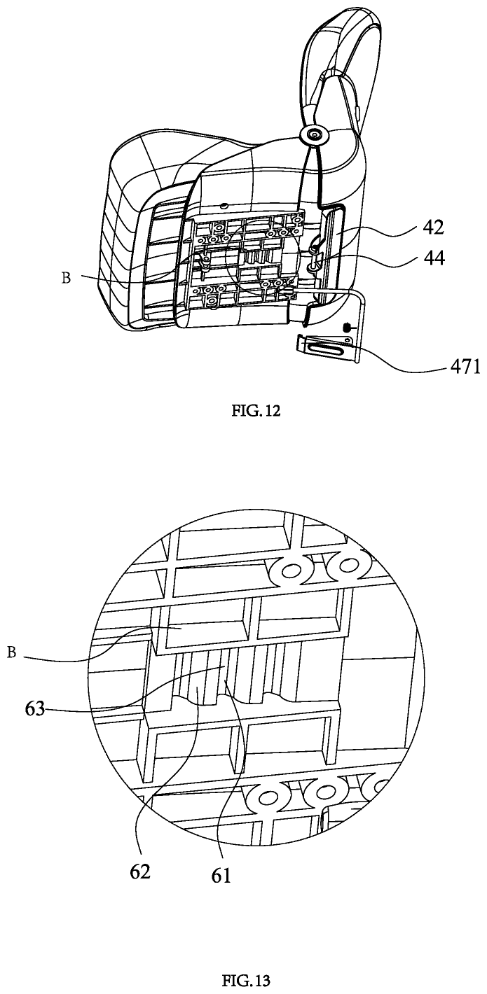

Referring to FIG. 8-12, the backrest adjustable seat includes a cushion 1 and a backrest 2, the backrest 2 is rotationally connected on one side of the cushion 1, the bottom of the cushion 1 is equipped with an adjusting base 10, the adjusting base 10 is provided with a backrest adjusting mechanism 40 for adjusting the rotating angle of the backrest 2 backward.

Preferably, the backrest adjusting mechanism 40 comprises an adjusting handle 41, a limiting and sliding block 42, and a torsion spring 46.

The adjusting base 10 comprises an adjusting plate 11 installed at the bottom of the cushion 1, and a supporting plate 12 extending upwards along one side of the adjusting plate 11, the adjusting plate 11 is provided with a clamping part 60.

The limiting and sliding block 42 is sliding connection with the supporting plate 12, one side, close to the adjusting plate 11, of the limiting and sliding block 42 is fixed with a rotating shaft 44, one side, far away from the adjusting plate 11, is propped against the bottom of the backrest 2.

One end of the adjusting handle 41 is fixed with a gear adjusting block 47, the other end of the adjusting handle extends out of the adjusting base 10 forming a handle 45 for pulling; the gear adjusting block 47 is provided with a clamping block 471 actively connected with the clamping part 60 and a connecting part 472 rotationally connected with the rotating shaft 44.

The torsion spring 46 is sleeved on the rotating shaft 44, two ends thereof are respectively extended with a torsion arm, one end of the torsion arm is fixedly connected with the gear adjusting block 47, the other end of the torsion 46 is fixed with the limiting and sliding block 42.

Preferably, the rotating angle that the backrest 2 can be rotated in a range of 0°˜130°.

Preferably, the clamping part 60 is composed of three clamping grooves 61 arranged in turn from left to right, when assembling, the clamping block 471 is just located in any one of the three clamping grooves 61.

Preferably, a bump 62 is arranged between the two adjacent clamping grooves 61, the left side of the bump 62 is provided with a circular arc part 63 connected with the top of the right side wall of the clamping grooves 61. Accordingly, it is convenient for the clamping part 60 to move, improves the rationality of the structure of clamping grooves, and ensures that the clamping part 60 moves more smoothly.

Preferably, the limiting and sliding block 42 is provided with sliding columns 421, the supporting plate 12 is provided with sliding grooves 121 corresponding to the position of the sliding columns 421; the sliding columns 421 extend into the sliding grooves 121, and are sliding connection with the sliding grooves 121.

Preferably, each of the sliding grooves 121 is provided with an elastic buffer piece 123, one end of the elastic buffer piece 123 is fixed with the sliding groove 121, the other end of the elastic buffer piece 123 is fixed with one side of the limiting and sliding block 42 close to the adjusting plate 11. When the limiting sliding block 42 is pressed, it slides in the direction of the elastic buffer piece 123 and compresses the elastic buffer piece 123. The elastic buffer piece 123 plays a role in buffering the impact force between the backrest 2 and the limiting and sliding block 42, thereby prolonging the service life of the seat. The elastic buffer piece 123 in the present disclosure is a spring.

Preferably, the clamping block 471 is located in the right one of the clamping grooves 61, the backrest 2 can rotate backward at an angle 10°.

Preferably, the clamping block 471 is located in the left one of the clamping grooves 61, the backrest 2 can rotate backward at an angle 30°.

The working principle of the present disclosure is as follows:

When the backrest 2 and the cushion 1 is in a folded state, the included angle α is equal to 0, at this time, the backrest 2 and the limiting and sliding block 42 are separated.

When the backrest 2 is opened, the included angle α is equal to 100°, at this time, the bottom of the backrest 2 and the top part of the limiting and sliding block 42 is propped against for limiting the backrest 2 to rotate backward.

When the user applies a downward force on the handle 45, the connecting part 472 of the adjusting handle 41 is driven to rotate along the rotating shaft 44, thereby driving the clamping part 60 to move downwards and separating from the clamping grooves 61, so that the limiting and sliding block 42 can move. At this time, the user properly applies force to the backrest 2, the backrest 2 rotates backward and presses the limiting and sliding block 42 downwards, the limiting sliding block 42 is connected with the gear adjusting block 47 to move from the right to the left. At the time when the backrest 2 rotates to the included angle α equal to 120°, the gear adjusting block 47 moves from the right clamping grooves 61 to the adjacent middle clamping groove 61. If the user releases the adjusting handle 41, the gear adjusting block 47 is clamped in the middle clamping groove 61 and cannot move anymore, namely finishing the adjustment of the backrest 2. Of course, when the backrest 2 rotates to the included angle α equal to 130°, the gear adjusting block 47 can be clamped into the left clamping groove 61, the backrest 2 reaches the maximum rotating angle.

The backrest adjustable mechanism with the reasonable structure, solves the problem that the backrest 2 of the existing electric scooter can only be fixed in a seat at a specific angle, for different users, the needs of the include angle between the backrest 2 and the cushion 1 is different, thus the inconvenience is caused.

The above is only the preferred embodiment of the present disclosure, the structure is not limited to the listed shape, any modification in the spirit and principle of the present disclosure, equivalent replacement and improvement and so on, are contained in the protection range of the present disclosure.

What is claimed is:

1. A backrest adjusting mechanism, wherein comprising an adjusting base, a cushion, a supporting frame, a backrest, an air pressure rod, a connecting rod and a steel wire core;
said cushion is fixed to a top of said adjusting base; said supporting frame is rotationally connected to a rear end of said base; said backrest is fixed on said supporting frame; said air pressure rod is rotationally connected with said supporting frame; said rear end of said base is provided with a fixing frame; one end of said connecting rod is rotationally connected on said fixing frame, the other end of said connecting rod is rotationally connected with a movable rod of said air pressure rod; said connecting rod and said fixing frame are both provided with a limiting block; when said backrest is used, two of said limiting blocks are propped against each other to fix said backrest at a specific position; one side of said adjusting base is actively connected with a buckle plate; one end of said steel wire core is fixed on a valve core switch of said air pressure rod, the other end of said steel wire core is fixed on said buckle plate.

2. The backrest adjusting mechanism according to claim 1, wherein said air pressure rod can drive an included angle between said backrest and said adjusting base to be changed in a range of 100°˜120°.

3. The backrest adjusting mechanism according to claim 1, wherein a bottom of said adjusting base is provided with a protective tube, one end of said protective tube is fixed on said adjusting base, the other end of said protective tube is fixed on said movable rod of said air pressure rod;
said steel wire core is received in said protective tube.

4. The backrest adjusting mechanism according to claim 1, wherein one side of said adjusting base is fixed with two lower supporting lugs; two ends of said buckle plate are actively connected with said two lower supporting lugs.

5. The backrest adjusting mechanism according to claim 1, wherein a rear end of said supporting frame is fixed with two upper supporting lugs; said air pressure rod is rotationally connected on said two upper supporting lugs.

6. The backrest adjusting mechanism according to claim 1, wherein two ends of said steel wire core are respectively provided with a clamping block; said buckle plate and said valve core switch of said air pressure rod are respectively provided with a clamping groove corresponding to said clamping block; said clamping block is clamped in said clamping groove.

7. The backrest adjusting mechanism according to claim 1, wherein said bottom of said adjusting base is provided with a plurality of mounting holes and a plurality of mounting grooves.
